(19) United States
(12) Patent Application Publication
(10) Pub. No.: US 2026/0110362 A1
(43) Pub. Date: Apr. 23, 2026

(54) Valve With Improved Internal Alignment

(71) Applicants: Ian Martin Rodgers, Itasca, IL (US); Moises Contreras Hernandez, Itasca, IL (US)

(72) Inventors: Ian Martin Rodgers, Itasca, IL (US); Moises Contreras Hernandez, Itasca, IL (US)

(21) Appl. No.: 19/308,465

(22) Filed: Aug. 25, 2025

Related U.S. Application Data
(60) Provisional application No. 63/710,691, filed on Oct. 23, 2024.

(51) Int. Cl. F16K 1/32; F24H 15/36

(52) U.S. Cl. CPC F16K 1/32; F24H 15/36

(57) ABSTRACT

A valve having improved internal alignment has at least one if not two chamfers: one possibly on and end of a shaft which at least selectively contacts a plunger which cooperates with a valve seat for a shut or off configuration and is moved by the plunger off there of (and possibly held off with a solenoid) in an on or open configuration, and the other on the plunger which at least selectively receives the shaft. The shaft and plunger auto align, which in turn, aligns the plunger with the valve seat, thereby permitting smaller diameter plungers relative to valve seats to be used.

### CLAIM OF PRIORITY

This application claims the benefit of U.S. Provisional Application No. 63/710,691 filed Oct. 23, 2024, which is incorporated herein by reference in its entirety.

### FIELD OF THE INVENTION

The present invention relates to a gas valve, and more preferably to a gas valve for a standing pilot gas water heater, and still more preferably to valves which traditionally provide for 20% larger plunger diameters than valve seats to accommodate stack tolerances.

### BACKGROUND OF THE INVENTION

Manual spring brake actuators typically employ a shaft having a flat end portion which contacts a flat surface at a top of the actuator plunger in the closed or shut position. The pushing force of the shaft pushes the plunger to off of the valve seat. Engaging a magnetic force to the actuator holds the plunger off of the valve seat to provide an open position.

For prior art valves, the diameter of the plunger sealing surface is normally at least 20% larger than the valve seat (the cavity sealing diameter) to avoid leaks caused by acentric misalignment of the actuator against the sealing area sealing diameter.

By oversizing the sealing surface of the plunger or reducing the diameter of the valve seat and sealing surface of the gas passageway, there are drawbacks in the form of increased cost, reduced capacity and/or reduced safety.

A need exists to provide better alignment than prior art designs for sealing safety valves for use with gas valves for water heaters, if not other uses as well.

### SUMMARY OF THE INVENTION

It is an object of many embodiments of the present invention to provide an improved safety valve for use with water heaters.

It is another object of many embodiments of the present invention to provide increased plunger to valve seat alignment in manually activated gas valves when in a closed position.

It is another object of the present invention to provide an improved valve having increased alignment capability of its plunger relative to valve seat over prior art designs.

Accordingly, in accordance with a presently preferred embodiment of the present invention, a gas valve preferably has a plunger which moves intermediate an open and a closed position. Many embodiments relate to a manually activated, magnetically operated safety valve for use with a standing pilot of a gas water heater. These valves allow gas flow to a pilot light and the inlet to another gas valve, which, when activated, supplies the main burner of the water heater with gas flow.

In order to overcome prior art issues related to misalignment, decrease cost and increase safety, the applicant has developed an alignment system whereby a shaft extends, presumably from a manual push button. Instead of having a flat end which contacts a flat upper surface of a plunger to move the plunger from the valve seat, the shaft has a chamfer or cooperating angled/curved surface with contacts a chamfered surface at an upper surface of the plunger to thereby assist in aligning the shaft with the plunger along an intended axis of the plunger and shaft. When the shaft and the plunger contact one another, they auto-align.

Since the plunger is now aligned on the axis of intended operation, the plunger/valve seat (or cavity) overlap may be reduced from 20% to no more than 10%, if not 5% thereby increasing at least one of safety, capacity and efficiency (reduced costs).

### BRIEF DESCRIPTION OF THE DRAWINGS

The particular features and advantages of the invention as well as other objects will become apparent from the following description taken in connection with the accompanying drawings in which:

FIG. 1 is a cross-sectional view of a valve of a presently preferred embodiment of the present invention in a closed position; and

FIG. 2 is a cross-sectional view of the valve of FIG. 1 in an open position.

### DETAILED DESCRIPTION OF THE PREFERRED EMBODIMENTS

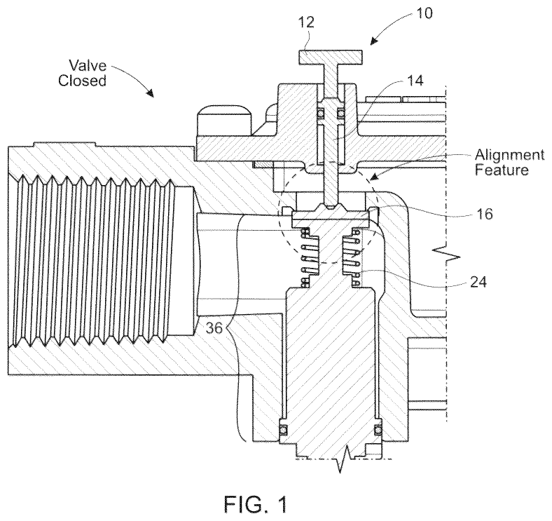

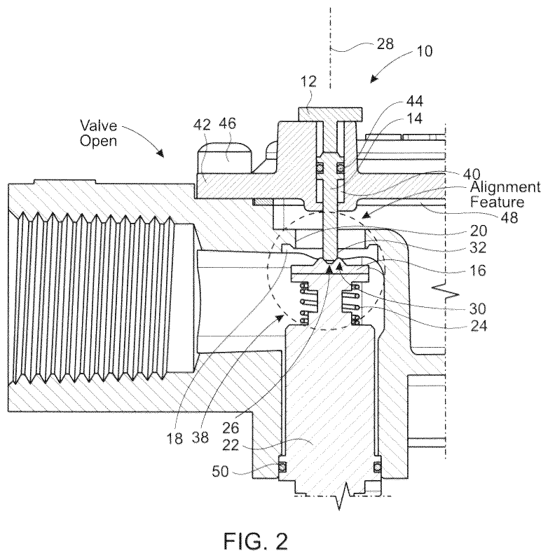

FIGS. 1 and 2 show a valve 10, such as a gas safety valve for a standing pilot gas water heater, in a closed and open position, respectively. Button 12, or other mechanism, may direct shaft 14 to contact plunger 16 to move the valve 10 from the closed position to the open position by displacing an upper surface 18 of the plunger off of a valve seat 20. Once in the open position as shown in FIG. 2, pole piece 22 may be engaged to hold the plunger 16 as shown in FIG. 2 without a need to continue depressing button 12. The bias of spring 24 may be overcome in the open position. When the pole piece 22 is de-energized, bias of spring 24 may push the plunger 16 against valve seat 20 into the closed position.

Valves 10, such as the one illustrated, may be utilized to allow gas flow to a pilot and the inlet to another gas valve (not shown) which, when activated, provide a main burner with gas flow for a gas water heater. Other uses for valves 10 may exist in the marketplace as well.

Shaft 14 is different from prior art shafts, as is plunger 16. Specifically shaft 14 has a first chamfer 26 at end 30 which is not planar in a direction perpendicular to axis 28. First chamfer 26 may be angled and/or curved narrowing from a larger cross section and/or diameter to a narrower cross section and/or diameter as it proceeds toward end 30.

Additionally, plunger 16 has a cooperating second chamfer 32 which contacts first chamfer 26 so as to assist in aligning the plunger 16 with shaft 14 along axis 28 as the plunger 16 heads back towards the valve seat 20 into the closed positions shown in FIG. 1. Second chamfer 32 may be angled and/or curved enlarging from a narrower bore cross section and/or diameter to a larger bore cross section and/or diameter as it proceeds away from spring 24 (oppositely from pole piece 22 aka actuator).

With at least one of the two chamfers 26,32, if not both, the shaft 14 and plunger 16 auto-align along the axis 28, which is also preferably an axis of the valve seat 2, when touching each other. With the plunger along the axis 28, the plunger/cavity or valve seat overlap can be reduced from its prior art overlap of 20% to less than about 10% or even 5% in many embodiments. This improvement has been found to increase safety, decrease costs and/or potentially increase capacity for at least some valve configurations.

Accordingly, a valve 10 is provided having a plunger 16 resiliently biased towards a closed position, such as by a spring 24. A shaft 14 preferably assists in aligning the plunger 16 with a valve seat 20 by providing first and second chamfers 26,32 which preferably cooperate when in contact to align the plunger along an axis 28 of the valve seat 20 also known as a cavity sealing surface. In fact, the chamfers 26,32, at least one, if not both, preferably auto-align the plunger 16 with the valve seat 20 along the axis 28 in many embodiments when in contact with one another, particularly as the plunger 16 transitions from the open to the closed positions. It could be that end 30 has a protrusion such as a first chamfer 26, but plunger 16 has a receiver such as a bore of constant diameter that first chamfer 26 consistently locates and inserts itself to be aligned along axis 28. Similarly, it could be that plunger 16 has second chamfer 32 and protrusion of shaft is flat (not chamfered) but constantly finds it way to the bottom of second chamfer 32, aligned along axis 28. Finally, other embodiments may connect shaft 14 to plunger 16 such as by screwing etc. so as to maintain alignment, etc.

Housing 34 preferably receives an actuator assembly 36 having the plunger and pole piece 22 permitting the plunger 16 to move within cavity 38 into contact with the valve seat 20 in the closed position. The actuator assembly 36 is preferably located opposite a passage 40 which could be in the housing 34 or another portion of the valve 10 such as a cover 42. A seal 44, such as an O-ring, may prevent fluid passing through the passage 40. Bolt 46 is shown connecting cover 42 to housing 34. Passage 40, shaft 14, valve seat 20, and plunger 16 are shown aligned along axis 28 in the preferred embodiment. Gasket 48 may provide a fluid seal between cover 42 and housing 34 for at least some embodiments. Seal 50 may assist in providing a seal of the actuator assembly 36 relative to the housing 34 for at least some embodiments.

Passage 40 may have throat 52 having a narrower cross section than at least some other portions of passage 40 to assist in maintaining shaft 14 along axis 28.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A valve comprising:
a plunger selectively movable onto a valve seat for a closed configuration and off the valve seat for an open configuration;
a spring biasing the plunger towards the closed configuration;
a solenoid which may be selectively engaged to at least selectively maintain the open configuration;
a shaft which may at least selectively engage the plunger oppositely disposed relative to the spring;
said shaft having a first chamfer at first end at least selectively contacting the plunger, said first chamfer narrowing from a larger cross section to a smaller cross section proceeding towards the first end, and
said plunger having a receiver receiving the first chamfer thereby assisting in aligning the plunger with the valve seat.

2. The valve of claim 1 wherein the receiver of the plunger further comprises a second chamfer narrowing from a larger cross section to a smaller cross section proceeding into the plunger.

3. The valve of claim 2 wherein the first chamfer is at least one of angled and curved as the shaft narrows in cross section towards the first end.

4. The valve of claim 3 wherein the second chamfer is at least one of angled and curved as the shaft narrows in cross section proceeding inwardly of the plunger.

5. The valve of claim 2 wherein the second chamfer is at least one of angled and curved as the shaft narrows in cross section proceeding inwardly of the plunger.

6. The valve of claim 1 wherein the plunger and valve seat reside in a housing and the shaft is actuated from external to the housing through a passage.

7. The valve of claim 6 wherein the passage is located through a cover on the housing.

8. The valve of claim 6 further comprising a seal about the shaft within the passage preventing fluid flow through the passage.

9. A valve comprising:
a plunger selectively movable onto a valve seat for a closed configuration and off the valve seat for an open configuration;
a spring biasing the plunger towards the closed configuration;
a solenoid which may be selectively engaged to at least selectively maintain the open configuration;
a shaft which may at least selectively engage the plunger oppositely disposed relative to the spring;
said plunger having a second chamfer at least selectively contacting a first end of the shaft, said second chamfer narrowing from a larger cross section to a smaller cross section proceeding into the plunger thereby assisting in aligning the plunger with the valve seat as the shaft aligns the plunger as the shaft pushes against the plunger.

10. The valve of claim 9 wherein the shaft has a first chamfer at first end at least selectively contacting the plunger, said first chamfer narrowing from a larger cross section to a smaller cross section proceeding towards the first end.

11. The valve of claim 10 wherein the first chamfer is at least one of angled and curved as the shaft narrows in cross section towards the first end.

12. The valve of claim 11 wherein the second chamfer is at least one of angled and curved as the shaft narrows in cross section proceeding inwardly of the plunger.

13. The valve of claim 9 wherein the second chamfer is at least one of angled and curved as the shaft narrows in cross section proceeding inwardly of the plunger.

14. The valve of claim 9 wherein the plunger and valve seat reside in a housing and the shaft is actuated from external to the housing through a passage.

15. The valve of claim 14 wherein the passage is located through a cover on the housing.

16. The valve of claim 14 further comprising a seal about the shaft within the passage preventing fluid flow through the passage.

17. A valve comprising:
a plunger selectively movable onto a valve seat for a closed configuration and off the valve seat for an open configuration;
a spring biasing the plunger towards the closed configuration;
a solenoid which may be selectively engaged to at least selectively maintain the open configuration;
a shaft which may at least selectively engage the plunger oppositely disposed relative to the spring;
said shaft having a first chamfer at first end at least selectively contacting the plunger, said first chamfer narrowing from a larger cross section to a smaller cross section proceeding towards the first end, and
said plunger having a second chamfer narrowing from a larger cross section to a smaller cross section proceeding into the plunger and cooperating with the first chamfer whereby the first and second chamfers cooperate to align the plunger relative to the valve seat.

18. The valve of claim 17 wherein the first chamfer is at least one of angled and curved as the shaft narrows in cross section towards the first end.

19. The valve of claim 18 wherein the second chamfer is at least one of angled and curved as the shaft narrows in cross section proceeding inwardly of the plunger.

20. The valve of claim 17 wherein the plunger and valve seat reside in a housing and the shaft is actuated from external to the housing through a passage.
